(19) United States
(12) Patent Application Publication
(10) Pub. No.: US 2014/0313351 A1
(43) Pub. Date: Oct. 23, 2014

(54) METHOD AND SYSTEM FOR CONCATENATING VIDEO CLIPS INTO A SINGLE VIDEO FILE

(71) Applicant: OneStory Inc., Saskatoon (CA)

(72) Inventors: Dale Zak, Saskatoon (CA); Dmitri Dolguikh, Saskatoon (CA)

(73) Assignee: OneStory Inc., Saskatoon (CA)

(21) Appl. No.: 14/255,489

(22) Filed: Apr. 17, 2014

(30) Foreign Application Priority Data
Apr. 19, 2013 (CA) 2813375

(51) Int. Cl. H04N 1/00; G11B 27/022; G06F 3/00

(52) U.S. Cl. CPC H04N 1/00204; G06F 3/005; G11B 27/022; H04N 2201/0008; H04N 2201/0096
USPC 348/207.1; 386/285

(57) ABSTRACT

A method, system and data structure for concatenating a series of video files into a single video file is provided. A remote device having a video camera and a microphone can be used to record a series of video files where each video file contains an answer to an interview question and comprises both video data and audio data. The series of video files can then be uploaded to a server over a network where the series of files are concatenated into a single video file containing both audio data and video data.

The present invention relates to a method, system and data structure for recording a series of video files on a remote device and using remote servers to concatenate the series of video files into a single video file.

### BACKGROUND

Many websites such as YouTube™, Vimeo™, etc. now allow people to upload video files so other people can view these videos using a computer or other device connected to the internet and running a web browser. Some of these sites have become extremely popular such as YouTube™ that reports billions of views a day.

Part of the popularity of these sites is likely a result of it having become increasingly easier to record videos because video recording equipment has become much more common and obtainable. For example, most smart phones now incorporate video cameras and microphones that allow the owner of the smart phone to record videos with these devices. For desktop computers and laptops, web cameras are commonly built into these devices and if a computer does not have a built in web camera, relatively inexpensive web cameras can easily be obtained to work with the computer and allow the recording of video and sound on the desktop computer or laptop.

However, most of these sites simply allow the uploading of a video. Typically this means a person will either directly upload a video they have recorded or they may upload a video that they have altered with video editing equipment on their computer before uploading to these sites. Some of these sites like Vine™ or Instagram™ do offer some video editing, but it is usually quite limited. These websites typically just receive video in any format and content that a user uploads.

### SUMMARY

In one aspect, a method for concatenating a series of video files into a single video file is provided. The method comprises: using a remote device having a video camera and a microphone to record a series of video files on the remote device wherein each video file contains an answer to an interview question and comprises video data and audio data; uploading the series of video files from the remote device to a server over a network; and concatenating the series of video files into a single video file containing audio data and video data.

In another aspect, a memory for storing data for access by a program being executed on a data processing system is provided. The memory stores a data structure for creating a series of videos files and concatenating the series of video files into a single video file. The data structure comprises: a plurality of question objects, each question containing data of an interview question; a plurality of interview objects, each interview object associated with a set of the plurality of question objects; a story object associated with one of the plurality of interview objects; and a plurality of video file objects associated with the story object, each video file associated with a video file comprising video data and audio data.

In another aspect, a system for concatenating a series of video files into a single video file is provided. The system comprises: a remote device having a video camera and a microphone, the remote device operative to record a series of video files wherein each video file contains an answer to an interview question and comprises video data and audio data; and a server operatively connected to the remote device through a communication network and operative to receive the series of video file from the remote device and concatenate the series of video files into a single video file containing audio data and video data.

### DESCRIPTION OF THE DRAWINGS

An embodiment of the present invention is described below with reference to the accompanying drawings, in which:

FIG. 1 is a system diagram of a network that allows a user to create a story;

FIG. 2 is a flowchart of a method for recording a user's story;

FIG. 3 illustrates a logical data model of a number of data structures that could be used in the creation of a story;

FIG. 4 is a system flowchart showing the uploading a series of video files and information from a remote device and creating a single story video file; and

FIG. 5 is a flowchart of a method for creating a single story video file from a series of video files and information.

### DETAILED DESCRIPTION OF THE ILLUSTRATED EMBODIMENTS

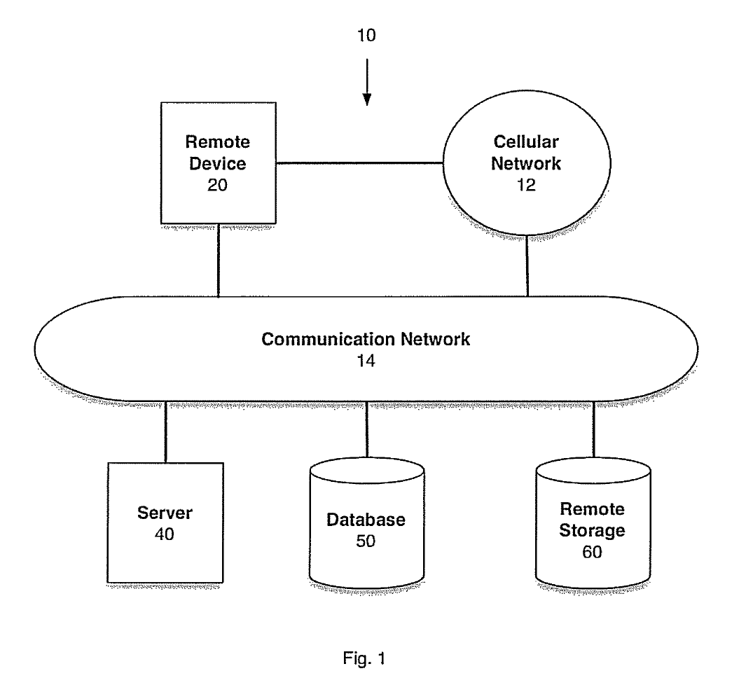

FIG. 1 illustrates a system 10 of components that can be used to allow a user of a remote device 20, such as a mobile device or other data processing device running a web application, to interview themselves or another person and record both video and audio of answers to interview questions in a series of video files which are then uploaded to a server 40, such as an API server, and stitched together to form a single video file or “story”. These videos or “stories” can then be watched by other people, such as with another mobile device or other data processing system using a web browser.

The system 10 can include a remote device 20, such as a mobile device or other data processing device running a web application. The remote device 20 can be connected through a cellular network 12 and then a communication network 14 such as the internet to the other components in the system 10. Alternatively, the remote device 20 may be connected directly to the communication network 14 (such as by a wireless router to the communication network 14). If the remote device 20 is a mobile device, the mobile device can be any suitable handheld computing device such as a smart phone that can run applications, display data and have a video camera and microphone to record video and audio. Most commercially available smart phones now offer all of this functionality. If the remote device 20 is a data processing application running a web application, the data processing system can be a desktop computer, laptop, mobile device, etc. that has video and audio recording capabilities such as an external webcam with a microphone or integrated video camera with a microphone and is equipped with a web browser and web application.

The remote device 20 can be provided with an application that runs on the remote device 20 or web application running in a browser that allows the user to select from a number of different interviews where each interview contains a number of interview questions for the user of the remote device 20 to answer. For each interview question in the interview, the user of the remote device 20 can record themselves or another person answering the question. By recording a person answering each of the questions in the interview, a series of video files is created by the remote device 20.

A server 40, such as an API server, can be provided. The remote device 20 can be operatively connected through the communication network 14 to the server 40 so that the remote device 20 can obtain data from the server 40 and the server 40 can receive data such as a series of data files from the remote device 20. Additionally, the server 40 can control the storage of the data and the creation of the single video file using the series of video files transmitted from the remote device 20. The server 40 can also be used to create the single video file by stitching the series of video files together along with any additional video files containing additional video sequences to form the final single video file.

A database 50, such as cloud database, containing computer readable memory for storing data can be provided to store information relating to the story that is created by the user of the remote device 20. Optionally, remote storage 60, such as cloud storage for larger files, containing computer readable memory for storing data can also be provided for storing the raw video and image files on remote servers.

After the user of the remote device 20 has recorded a series of video files, answering each question provided in a selected interview, the remote device 20 can upload data related to the recorded series of video files and the series of video files to the server 40. The server 40 can then transmit data to the database 50 and the remote storage 60 to store the information related to the series of video files or the story, the series of video files and to create the single video file from the series of video files and the information provided along with them.

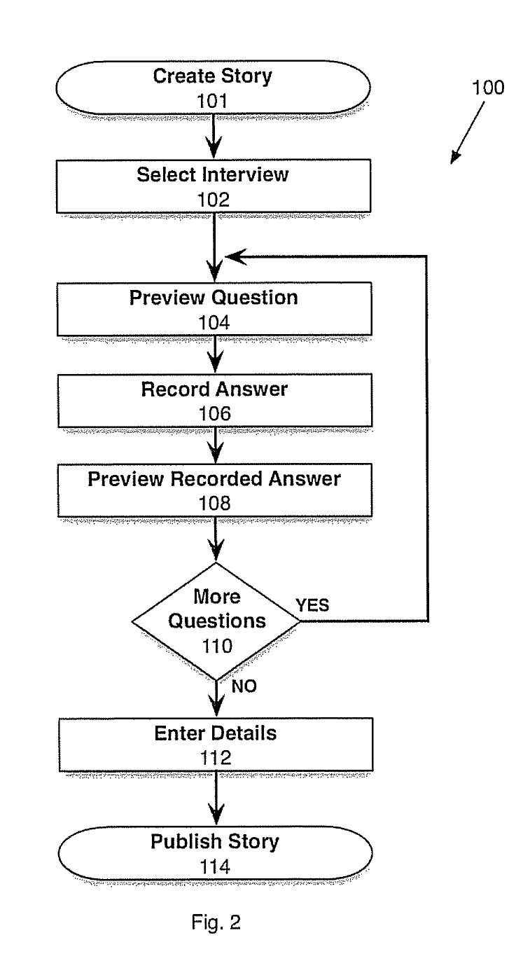

FIG. 2 illustrates a flowchart of a method for creating a story made up of a series of recorded video of answers to interview questions using the remote device 20. A user can use the remote device 20 to run an application or web application running in a browser that allows the user to create a story based on a series of interview questions. The user can first select a specific interview. Then, by answering the interview questions provided in the interview and recording themselves or another person answering each interview question using the video and sound recording capabilities of the remote device 20, the application can save a series of video files of the person being interviewed answering each of the interview questions in the interview they have selected. The series of video files created by the remote device 20 can then be uploaded to the server 40 where the series of video files will be used to construct a single video file or “story”.

The method 100 can begin with the user indicating that they want to create a story at step 101. The method 100 will move onto step 102 where the user can choose an interview. The remote device 20 can display to a user a list of selectable interviews and the user can choose one of these interviews. In one aspect, the list of interviews the user can select from can be grouped by topics, with a number of topics shown and one or more interviews shown for each topic.

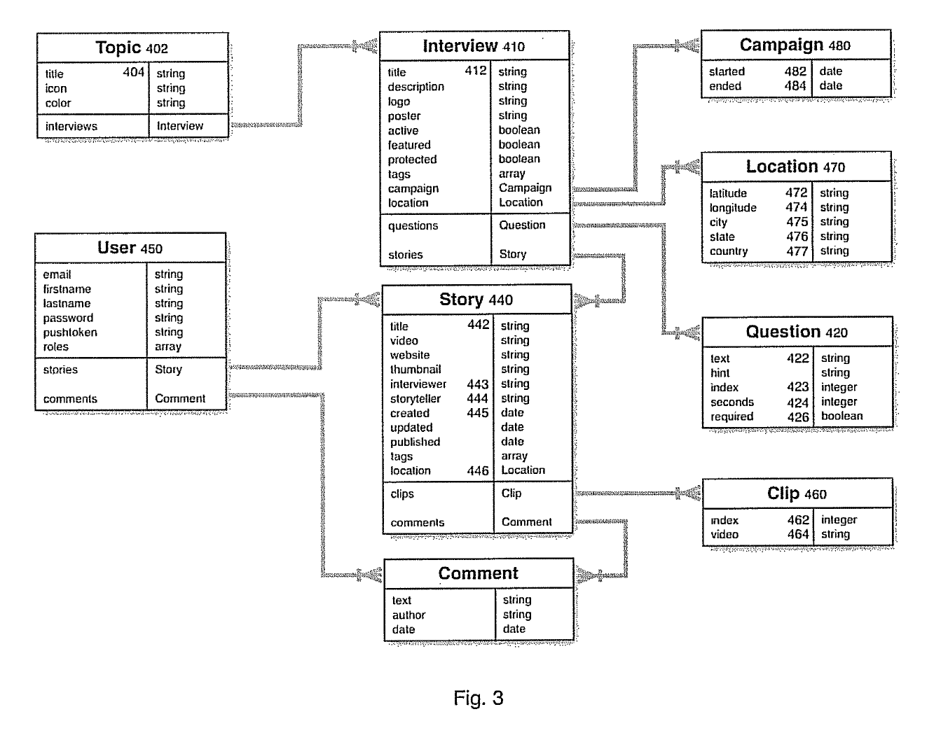

FIG. 3 illustrates a logical data model for one way that the interviews and resulting stories can be implemented as a data structure. There can be one or more topic objects 402 with each topic object having a title field 404 containing the title of the topic. The topic could be any sort of topic that an interview may relate to. For example, the title of various topics could be life, love, travel, family, etc.

Each topic object 402 can be related to one or more interview objects 410 so that there is an interview object 410 for each interview that relates to the topic of a topic object 402. Each interview object 410 can include a title field 412 for storing the name (title) of a particular interview.

Each interview object 410 can be associated with one or more question objects 420 where each question object 420 contains a question field 422 for storing an interview question to be asked of the user. The question object 420 may also include a time field 424 for storing a suggested time limit for the response of the user. The question object 420 could also include a required field 426 for storing an indicator of whether or not the question associated with the question object 420 requires an answer to the question to be recorded. If the required field 426 indicates that it is not required, the user of the remote device 20 could be given the option of skipping over the question and moving onto the next question associated with the interview without having to record an answer to this particular question.

In one aspect, each interview object 410 could also be associated with a location object 470. This location object 470 could include a latitude field 472 and a longitude field 474 to allow a precise position to be specified, a city field 475 for storing the name of a city along with a state field 476 and a country field 477 for storing the name of a state or province and a country, respectively. This location information can be used to geo-target specific interviews having only people in a certain geographic region able to retrieve certain interviews and upload video files of the answers to these certain interviews so that a specific geographic region can be targeted with an interview if desired and preventing users outside this geographic region from contributing recorded answers to these interviews.

Referring again to FIG. 2, at step 102, a user can view a list of topics where each topic has one or more interviews associated with it. In this manner, the user can first select a topic they are interested in creating a story for and then based on the user's selection of the topic, he or she will be shown a list of interviews associated with that topic that they can select from.

Once an interview has been selected by a user at step 102, the method 100 can move onto step 104 and an interview question can be displayed to the user so that they can preview the interview question. Referring to FIG. 3, each interview object 410 can be related to one or more question object 420 where each question object 420 has a text field 422 containing an interview question for the user. At step 104, the method 100 can display the interview question contained in the text field 422 of the first question object 420 associated with the interview object 410 that was selected by the user. The interview question can be displayed on the screen of the remote device 20 for the user to read and familiarize themselves with or to allow the user of the remote device 20 to read the interview question to another person that they are interviewing.

The question object 420 can also contain an index field 423 that indicates which interview question in the series of interview questions associated with an interview the current question object 420 relates to. The index field 423 can indicate which number in the series of interview questions the question object 420 is related to. For example, it could indicate the interview question in the question object 420 is the first interview question in a series, seventh, tenth, etc.

In one aspect, the suggested time contained in the time field 424 can also be displayed on the remote device 20 to provide the user with the time suggested for answering the question. This suggested time could be either optional or required.

Referring again to FIG. 2, once the user is familiar with the question and the user or other person being interviewed is ready to answer the question, the method 100 can move to step 106 and the user can record the answer to the interview question. Typically, the application being run on the remote device 20 will contain a button, such as a “Record Answer” button, that the user can select on the screen of the remote device 20 which will indicate that he or she is finished previewing the interview question and is ready to record the answer to the interview question.

In step 106 the remote device 20 can record video and audio allowing the user to record themselves, or another person they are interviewing, answering the interview question. In one aspect, when the user indicates that he or she is ready to record an answer to the interview question, the remote device 20 can display a full screen video recorder with an overlay showing text of the interview question and the time counter. Alternatively, the remote device 20 can display a modal popup with the video recorder showing an overlay with the text of the interview question and the time counter. When the user hits a record button on the screen of the remote device 20, the remote device 20 can start recording video and audio with a time overlay showing the elapsed time of the recording. In one aspect, if there is a suggested time for the answer to the interview question, the time counter can indicate when the suggested time has been reached, such as flashing or changing color or alternatively ending the recording of the video.

With the remote device 20 recording video and audio data, the user can point the camera of the remote device 20 at either themselves to record themselves answering the interview question or at another person if they are interviewing the other person. If the remote device 20 is a desktop computer, laptop computer, etc., the user can position themselves in front of the webcam or integrated video camera to record themselves answering the interview question.

After the user has recorded his or her answer to the interview question at step 106, the method can move onto step 108 and the user can preview the recorded answer. If they are not happy with the recorded answer they may be given the option of re-recording the answer.

If the user accepts the recorded video and audio of his or her answer, the method 100 can move onto step 110 where it will check to see if there is a next interview question associated with the interview the user has selected. Referring again to FIG. 3, the application can check if there is another question object 420 associated interview object 410 that corresponds to the interview the user has selected. If there is another question object 420, referring again to FIG. 2, the method 100 can move back to step 104 and display the interview question in the question field 422 of the next question object 420 on the remote device 20 so that the user can read the next interview question.

The method 100 will repeat steps 104, 106, 108 and 110 as long as there are more interview questions associated with an interview. Each time these steps are repeated, the next interview question will be displayed at step 104, the answer to the interview question recorded at step 106, the user previewing and accepting (or re-answering) the recorded answer at step 108 and then the method 100 checking to see if there are any more interview questions associated with the selected interview at step 110. In this manner, the method 100 will have the remote device 20 create a video file of the answer to each interview question associated with the interview the user has selected with the result being a series of video files being recorded and saved by the remote device 20, with each video file in the series of video files corresponding to each interview question associated with the selected interview.

When the user has recorded an answer to the last question and accepted the recorded answer and the method 100 reaches step 110 and there are no more questions for the user to answer, the method 100 can move onto step 112. At step 112 the user is prompted for details of the interview that they have just conducted. This information can be the name of the storyteller being interviewed, the title for the story entered by the user, the time the interview was conducted, tags to be associated with the story, and a location where the interview was done, such as the city, state/province and the country, etc. The user can enter this information into the remote device 20. Location information may also be taken directly from the remote device 20 if it is capable of determining its position, such as by GPS. Alternatively, if the remote device 20 is using a web application to connect to the server 40, the remote device 20 can utilize the browser location-aware services if available to determine the location of the remote device 20. If however location services are not available and the location is not detected, the user can optionally manually enter the city, state/province and country information into the remote device 20.

Referring again to FIG. 2, the information obtained at step 112 as well as the series of video files recorded and any other information related to the interview can be uploaded to the server 40 or “published” at step 114.

In one aspect, the interviews could be “geo-targeted” allowing a person submitting an interview to target a specific geographical location and only obtain interviews from people in the geographic location. At step 102 of the method 100 where the interviews are displayed the user for selection, the location of the remote device 20 could be used to filter the interviews the user is allowed to select from. This location of the remote device 20 could be entered by the user into the mobile device 20 (such as the city and state the user is located in) or it could be obtained from a location sensing mechanism on the remote device 20 (most smart phones and other mobile devices are able to determine position based on GPS signals). Typically, it is common for smart phones and other mobile devices to be equipped with a GPS device that can determine the location of the mobile device quite precisely. Using this location information of the remote device 20 at step 102, the method 100 at step 102 can filter the interviews the user is able to select based on the location of the user and the remote device 20, showing just the interviews that correspond with the location of the remote device 20 or that do not specify any specific geographic location. At step 102 a user may not be shown interviews that are related to different locations, but may only be shown interviews that relate to their location or do not have a location requirement. In this manner, stories to be collected from participants using a specific interview can be geo-targeted. By specifying a certain location, such as a city, state or country or an even more specific area or location, the creator of an interview can target one location where they want to gather stories from. For example, if a creator of an interview only wants to collect answers from a specific city, the creator can specify that the interviews are to be limited to only people in a specific city at step 102 and then only people in that location will be able to select the interview. This will allow a person to collect accurate user testimonies from only affected populations in specific geographic locations.

In another aspect, a campaign object 480 may be associated with an interview object 410 and used to limit the period in time in which stories can submitted for a specific interview. The campaign object 480 could contain a started date field 482 that contains a beginning date and an ended date field 484 that contains an end date. The date the series of video files are uploaded to the server 40 could be compared to the beginning date in the started date field 482 and the end date in the ended date field 484. If the date the series of video files were created or are being uploaded is between the beginning date and the end date then the series of video files can be accepted. However, if it falls outside these dates, the upload can be refused.

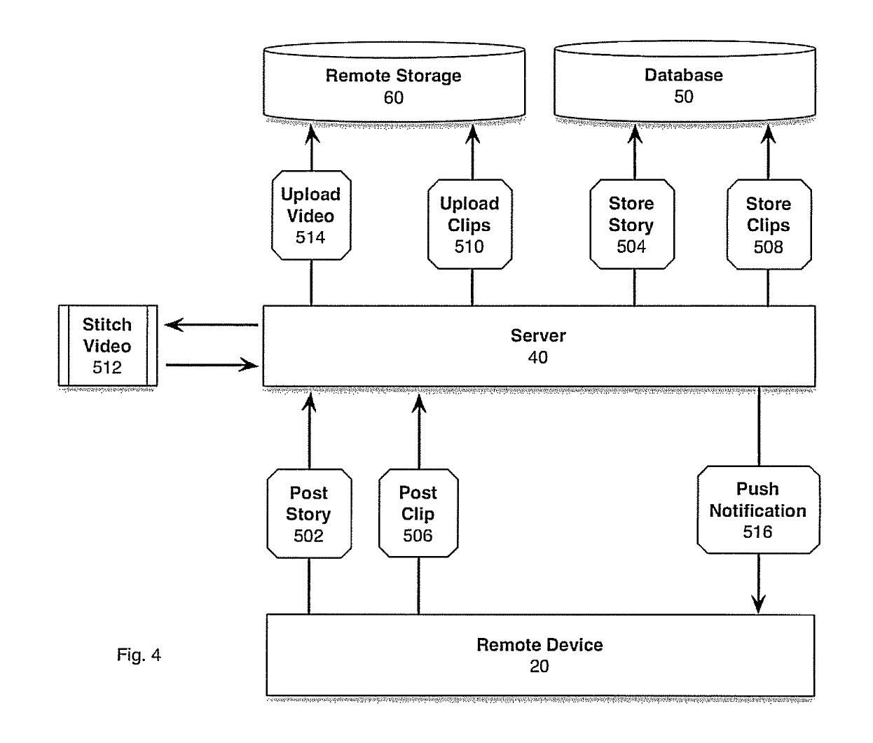

When a user selects to publish his or her story at step 114 of the method 100, the remote device 20 can upload the information and the series of video files created during the method 100 to the server 40 so that a single video file or story can be created by stitching the recorded series of video files together. FIG. 4 shows a system flowchart of the uploading of the series of video files and information related to the series of video files and the creation of a single video file using the series of video files.

When the user publishes his or her story at step 114 of method 100 in FIG. 2, the details associated with the story are uploaded to the server 40 at step 502 and these details can be transmitted at step 504 to the database 50 for storage. Referring to FIG. 3, these details can be used to populate a story object 440.

The title of the interview entered by the user at step 112 of method 100 can be inserted into a title field 442 of the story object 440, the name of the interviewer (user of the mobile device 20) can be inserted in the interviewer field 443 and the name of the storyteller (the person answering the questions) can be inserted into the storyteller field 444 in case the person answering the interview questions is a different person from the user of the remote device 20 that is recording the storyteller's answers. Additionally, the date the interview was recorded could be saved in the created field 445, the location where the interview took place could be saved in the location field 446 and any other information that may be useful could be obtained at this point.

Additionally, location information relating to where the series of video files were recorded could be used to create a location object 470 associated with the story object 440 that is created. The latitude and longitude of the remote device 20 when the story was published at step 114 of method 100 can be inserted in the latitude field 472 and longitude field 474, if this information is available. The city, state and country where the series of videos files were recorded can be inserted in the city field 475, state field 476 and country field 477 of the location object 470.

In one aspect, geo-targeting can be provided for by only allowing stories to be uploaded for certain interviews if the remote device 20 recorded the interview in a specified geographic location, thereby limiting submitted stories for certain interviews to only be recorded in a specific geographic location.

A user object 450 can also be created providing details of the user that recorded the interview and created the story.

Referring again to FIG. 4, at step 506 the series of video files recorded by the user on the remote device 20 can be uploaded to the server 40, where information about the series of video files can be transmitted to the database 50 at step 508. This information can be used to create a number of video file objects 460 as shown in FIG. 3, with each video file object 460 containing an index field 462 indicating which position the video file takes in the series of video files related to a specific story object 440 and a video field 464 indicating the video file associated with the video file object 460. The video field 464 could contain an address, such as an URL address, where the video file is being stored on the remote storage 60.

Optionally, at step 510 the series of video files can be uploaded to a different remote storage 60 for storage of the raw video files.

At step 512 the series of video files can be stitched together to form a single video file constituting the story. The server 40 can take the individual video files recorded by the remote device 20 and combine them into a single video file that can be shared with other people. Title sequences, credits and the interview questions that were asked can be provided in the single video file in the relevant places so that the single video file displays each question and then the recorded answer in series when it is viewed.

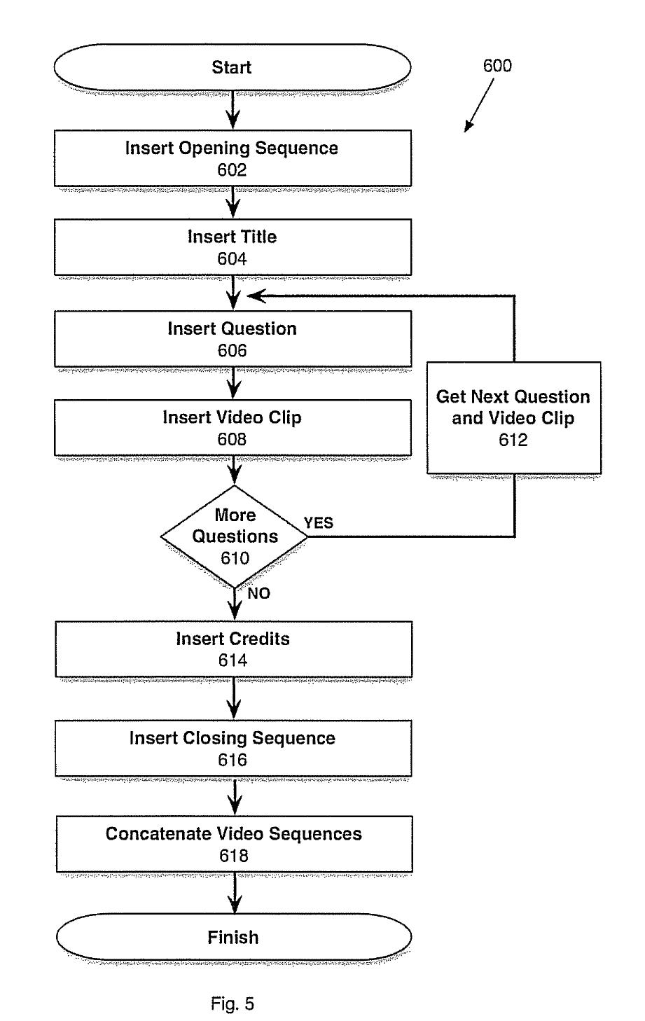

FIG. 5 illustrates a method 600 for stitching together the series of video files to form a single video file constituting the story. At step 602 an opening title sequence is created for the single video file. This opening title sequence can display information such as the organization that is provided from the server 40. At step 604 a title can be inserted into the video. The title can include the title assigned to the story by the user, such as the title stored in the title field 442 of the story object 440, the name of the storyteller and the date the interview was recorded.

After the title is constructed at step 604, the method 600 can insert the first question into the video at step 606. This first question portion can be the text of the first question that was asked of the user or it could be a recording of someone asking the question. After the first question is inserted in the video, the method 600 can move to the step 608 and insert the first video file showing the recorded answer to the question into the video.

At step 610 the method 600 can check to see if there are any more interview questions. If there are more interview questions the method 600 will obtain the next interview question and the next video file in the series of video files that contains the recorded answer at step 612 and then move to step 606, inserting the next interview question and at step 608, inserting the next video file of the recorded answer to the interview question. The method 600 will repeat steps 606, 608, 610 and 612 until each interview question and related video file of the recorded answer to the interview question have been inserted into the video and there are no more interview questions and video files when the method 600 reaches step 610.

Once all the questions and the video recording of the user's answers have been added to the single video file, the method 600 can move onto step 614 and insert credits in the method 600. The credits can again include the information about the story including the name of the storyteller, interviewer, date of the interview and the location of the interview and any other information from the story object 440 and user object 450. A closing sequence can then be added at step 616 showing a logo of the company providing the server 40.

Once all the video sequences have been placed in order, the method 600 can then move to step 618 and concatenate the video sequences into a single video file.

In another aspect, various themes could be provided that a user could select from. These themes could specify different or no opening sequences and/or credits, different methods of displaying the interview questions, etc.

Referring again to FIG. 4 once the single video file has been created at step 512 the single video can be uploaded at step 514 and the server 40 can send a notification to the remote device 20 at step 516.

The method shown in FIG. 4 can also be used to achieve geo-targeting of recorded stories, limiting the submission of stories related to a specific interview to only a selected geographic area. In addition to not displaying interviews at step 102 of method 100 that specify a geographic location that is different from where the user of the remote device 20 is located, when the information is passed to the server 40 at step 502, the server 40 can check the location information from the remote device 20 indicating where the interview was recorded against any location information specified for interview field. If the location where the interview was recorded does not correspond with the geographical are specified by the interview, the server 40 can refuse to accept the upload of the series of video files. In this manner, if a user tries to submit an interview that was recorded outside a geographical area specified for the interview, the uploading of the series of video files and related information can be refused, preventing interviews from outside the desired location from being submitted by a user.

Once a single video file has been created by the system, the single video file can be made available to others to watch, such as placing it on a website where it can be viewed by anyone with access to the internet and using a device with a web browser. Optionally the single video file can be made available for download so it can be viewed offline.

In one aspect, the stories available to be viewed by others can also be geo-targeted. A user accessing the various stories uploaded to the server 40 can have their own location information transmitted to the site where it can match up their location with the location where the various stories were recorded so that a user can see what stories were recorded near the current location. This geo-targeting could allow a user to watch stories from their own neighborhoods, cities, etc. or if they are traveling viewing stories from the places they are visiting.

In one aspect, interviews can be marked protected so that only specific users can submit story submissions for certain interviews. An interview can be associated with one or more users that are able to submit stories related to this interview. When the information and series of video files are submitted to the server 40 after step 502 shown in FIG. 4, the server 40 can check if the user attempting to submit the story associated with the interview is listed as an authorized user associated with the interview. If the user is one of these authorized users, the next steps can be performed and a single video file or story created. However, if the user trying to submit the story is not provided in the list of permitted users, the submitted series of video files and other information can be refused.

The protected interviews can still be made viewable by the general public, however, the people who are able to submit recorded interviews is limited in this manner. For example, a news agency could provide the interview on the system but only allow members of their own staff to submit recorded answers to the interview, thereby preventing people that do not work for the news agency from submitting interviews, thereby providing some control over the content of the stories created from the interview.

In another aspect, interviews can be marked private. This can allow the stories generated from these private interviews to only be viewable by certain people and not the general public. This access could be controlled by providing a list of users who are authorized to view the final story, requiring the submitter to invite other people to view it by providing special access via a token URL, requiring authentication, etc. In this manner, the people who can view a story can be restricted.

The foregoing is considered as illustrative only of the principles of the invention. Further, since numerous changes and modifications will readily occur to those skilled in the art, it is not desired to limit the invention to the exact construction and operation shown and described, and accordingly, all such suitable changes or modifications in structure or operation which may be resorted to are intended to fall within the scope of the claimed invention.

We claim:

1. A method for concatenating a series of video files into a single video file, the method comprising:
using a remote device having a video camera and a microphone to record a series of video files on the remote device wherein each video file contains an answer to an interview question and comprises video data and audio data;
uploading the series of video files from the remote device to a server over a network; and
concatenating the series of video files into a single video file containing audio data and video data.

2. The method of claim 1 further comprising using the remote device to select an interview associated with a plurality of interview questions and downloading the plurality of interview questions to the remote device.

3. The method of claim 2 wherein each interview question downloaded and associated with the selected interview is used to record a video file in the series of video files associated with the interview question.

4. The method of claim 3 wherein for each interview question associated with the selected interview, the remote device displays the interview question and then the remote device records a video file with an answer to the interview question.

5. The method of claim 2 wherein a plurality of interviews are associated with a topic.

6. The method of claim 3 wherein an interview is associated with a geographical location and the method further comprises using the remote device to obtain a geographical location of the remote device.

7. The method of claim 6 wherein only interviews associated with a geographical location that match the geographical location of the remote device are selectable to the remote device.

8. The method of claim 6 wherein the series of video files is only uploaded to the server if the geographical location associated with the selected interview matches the geographical location of the remote device.

9. The method of claim 6 wherein the geographical location of the remote device is a latitude and longitude.

10. The method of claim 6 wherein the geographical location of the remote device is at least one of a city, a state, a province and a country.

11. The method of claim 3 wherein the series of videos are concatenated into a single video file with each interview question being displayed before the video data and audio data of the answer to the interview question in the single video file.

12. The method of claim 1 further comprising making the single video file accessible to web browsers.

13. The method of claim 1 wherein the remote device is a mobile device.

14. The method of claim 1 wherein the remote device is a data processing system with a web application.

15. The method of claim 1 further comprising the remote device uploading information related to the series of video files to the server and the server using the information in the creation of the single video file.

16. A memory for storing data for access by a program being executed on a data processing system, the memory storing a data structure for creating a series of videos files and concatenating the series of video files into a single video file, the data structure comprising:
a plurality of question objects, each question object containing data of an interview question;
a plurality of interview objects, each interview object associated with a set of the plurality of question objects;
a story object associated with one of the plurality of interview objects; and
a plurality of video file objects associated with the story object, each video file object associated with a video file comprising video data and audio data.

17. The memory of claim 16 wherein the data structure further comprises at least one location object associated with one of the interview objects and including data indicating a geographical location to prevent access to the associated interview object by a device located in a different geographical region.

18. The memory of claim 16 wherein each question object further comprises an index field containing an identifier of a sequence for the questions associated with a single interview.

19. The memory of claim 16 wherein each question object further comprises a field indicating a suggested time for answering the interview question stored in the question object.

20. A system for concatenating a series of video files into a single video file, the system comprising:
a remote device having a video camera and a microphone, the remote device operative to record a series of video files wherein each video file contains an answer to an interview question and comprises video data and audio data; and
a server operatively connected to the remote device through a communication network and operative to receive the series of video files from the remote device and concatenate the series of video files into a single video file containing audio data and video data.

21. The system of claim 20 further comprising a database comprising computer readable memory and operatively connected to the server and wherein the server is further operative to receive information related to the series of video files and store the information in the database, and wherein the server is further operative to use the information in the creation of the single video file.

22. The system of 20 further comprising remote storage comprising computer readable memory and operatively connected to the server and where the server is further operative to transmit the series of video files to the remote storage.

23. The system of claim 20 wherein the remote device is further operative to select an interview associated with a plurality of interview questions and receive the interview questions from the server.

24. The system of claim 23 wherein each interview question is used to record a video file in the series of video files associated with the interview question on the remote device.

25. The system of claim 24 wherein an interview is associated with a geographical location and the method further comprises using the remote device to obtain a geographical location of the remote device.

26. The system of claim 25 wherein only interviews associated with a geographical location that match the geographical location of the remote device are selectable to the remote device.

27. The system of claim 25 wherein the series of video files is only uploaded to the server if the geographical location associated with the selected interview matches the geographical location of the remote device.

28. The system of claim 24 wherein the series of videos are concatenated into a single video file by the server with each interview question being displayed before the video data and audio data of the answer to the interview question in the single video file.

29. The system of claim 20 wherein the server is operative to make the single video file accessible to web browsers.

30. The system of claim 20 wherein the remote device is one of: a mobile device; and a data processing system with a web application.
